(19) United States
(12) Patent Application Publication
(10) Pub. No.: US 2019/0057146 A1
(43) Pub. Date: Feb. 21, 2019

(54) NON-LINGUISTIC CONTENT ANALYSIS SYSTEM

(71) Applicant: Colossio, Inc., Chicago, IL (US)

(72) Inventor: Joseph A. Jaroch, Chicago, IL (US)

(21) Appl. No.: 15/679,714

(22) Filed: Aug. 17, 2017

(51) Int. Cl. G06F 17/30; G06F 17/27

(52) U.S. Cl. CPC G06F 17/30684; G06F 17/277; G06F 17/2705; G06F 17/30699

(57) ABSTRACT

Methods for non-linguistic content analysis of a selected body of data are provided. In one aspect, a method includes identifying a delimiter token, parsing a reference base into reference units based on the delimiter token, calculating and storing a frequency of each occurrence of each reference unit of the reference base and a total number of occurrences of all reference units of the reference base, parsing the selected body of data into data units, calculating and storing a score for each data unit of the selected body of data, and providing a ranked list of concepts associate with the selected body of data. Systems and machine-readable media are also provided.

### TECHNICAL FIELD

The present disclosure generally relates to content analysis, and more specifically relates to a system for non-linguistic analysis of selected content to provide relevant associated concepts.

### BACKGROUND

Traditional computational content analysis provides for using algorithms to analyze a supplied body of text. However, conventional approaches require intimate knowledge of the language of the text or significant annotations to be supplied before deeper meaning can be derived. It is desired to identify key concepts referenced within a body of data without needing to understand the grammar or structure of the language associated with the body of data.

The description provided in the background section should not be assumed to be prior art merely because it is mentioned in or associated with the background section. The background section may include information that describes one or more aspects of the subject technology.

### SUMMARY

According to certain aspects of the present disclosure, a computer-implemented method for non-linguistic content analysis of a selected body of data is provided. In one embodiment, the method includes identifying a delimiter token and parsing a reference base into reference units based on the delimiter token. The method also includes calculating and storing a frequency of each occurrence of each reference unit of the reference base and a total number of occurrences of all reference units of the reference base. The method further includes parsing the selected body of data into data units, calculating and storing a score for each data unit of the selected body of data, and providing a ranked list of concepts associate with the selected body of data.

According to certain aspects of the present disclosure, a system for non-linguistic content analysis of a selected body of data is provided. The system includes a memory and a processor configured to execute instructions. The executed instructions cause the processor to identify a delimiter token; parse a reference base into reference units based on the delimiter token; calculate and store a frequency of each occurrence of each reference unit of the reference base and a total number of occurrences of all reference units of the reference base; parse the selected body of data into data units; calculate and store a score for each data unit of the selected body of data; and provide a ranked list of concepts associate with the selected body of data.

According to certain aspects of the present disclosure, a non-transitory machine-readable storage medium comprising machine-readable instructions for causing a processor to execute a method for providing non-linguistic content analysis of a selected body of data is provided. The method includes parsing a reference base into reference units based on a delimiter token. The method also includes calculating and storing a frequency of each occurrence of each reference unit of the reference base and a total number of occurrences of all reference units of the reference base. The method further includes parsing the selected body of data into data units, calculating and storing a score for each data unit of the selected body of data and providing a ranked list of concepts associated with the selected body of data.

It is understood that other configurations of the subject technology will become readily apparent to those skilled in the art from the following detailed description, wherein various configurations of the subject technology are shown and described by way of illustration. As will be realized, the subject technology is capable of other and different configurations, and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for providing interactive content and information that are related to selected content or a suggested completion of one or more written words.

FIG. 2 is a block diagram illustrating an example client and server from the architecture of FIG. 1 according to certain aspects of the disclosure.

FIG. 3 is an example process associated with the disclosure of FIG. 2.

FIG. 4 is an example process associated with the disclosure of FIG. 2.

FIG. 5 is an example process associated with the disclosure of FIG. 2.

FIG. 6 is an example process associated with the disclosure of FIG. 2.

FIG. 7 is a block diagram illustrating an example computer system with which the clients and server of FIG. 2 can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

### General Overview

In one embodiment, the disclosed system provides identification of key concepts referenced within a body of data without needing to understand the grammar or structure of the language.

Specifically, the conventional concepts of “words” and “sentences” are generalized where no assumptions are made about the structure of the language. This allows the system to be applied to any textual language, as well as to pictograms, hieroglyphics, emoji, languages, etc., which are otherwise not deciphered or understood. Where the term “text” would ordinarily be used, the term “data” is used throughout to denote that a more general approach to any type of content is conveyed.

This content analysis may be performed automatically, removing any requirement for keyword annotation or subject distinction (e.g., manual entry of search terms). The output may be a sorted and scored table of the most important concepts in the data and how those concepts interrelate. Accordingly, the output may identify the most pertinent groups (e.g., two or more) of concepts to automatically identify the core subject matter of a particular body of data.

An example of this system is an indexing engine used by a company, where the indexing engine is intended to find relevant content in a large quantity of internal intellectual property based on a set of input parameters that span a variety of languages and document formats. Such a system is superior to existing technology that is generally based around latent semantic analysis. Further, this system is agnostic to input type/language and does not require metadata to be produced. Thus, this system provides more precise results as it relates each concept to a reference baseline, which significantly reduces noise.

This system may provide for using computational sociolinguistics to identify patterns in user speech by highlighting phrases and concepts mentioned more regularly by a particular user relative to the overall population of users. The system may also highlight the differences in memes posted by particular users, emoji, and other non-textual data, allowing for more generic interpretation of a historical corpus of social media posts.

The disclosed system addresses a technical problem tied to computer technology and arising in the realm of computer networks, namely the technical problem of identifying key concepts referenced within a body of data without needing to understand the grammar or structure of the language/data, and without needing manual metadata creation. The disclosed system solves this technical problem by analyzing one or more databases of possible information to identify relevant information that is most suitable for displaying with regards to the body of data, and obtaining such information over a network if it is not available on a user's device. The disclosed system provides a solution necessarily rooted in computer technology as it relates to the analysis of a body of data to identify, and obtain, suitable relevant information to display with the body of data or in response to a selection of the body of data. For example, the disclosed system facilitates allowing content or data to be automatically identified and displayed when a body of data is selected (e.g., an academic paper or an article). As a result, a richer user experience may be provided with regard to obtaining relevant information for any data of interest. In addition, the system drastically reduces the processor, memory and network bandwidth requirements required for providing the most relevant content or data associated with a specific body of data, as well as eliminating the need for user or manual input regarding the body of data. The system thereby improves the efficiency of the computer and/or the network, as well as drastically improves the relevance of the identified content/data to be associated with a specific body of data.

This system may be used for a variety of tasks where a user wants to understand broad-stroke meaning of a given body of text without spending an inordinate amount of time reading the entire text. For example, the system is particularly useful for parsing through academic research papers, press releases, corporate documentation, and textbooks. Additionally, the system is designed to function on smaller and less structured bodies of data like Tweets, Facebook posts, and other social media content.

In one or more aspects, the system removes the conventional need for manual metadata creation. The system produces the metadata itself and can act as an initial filter for search indexers, for asset management tools and for users looking to narrow down a set of queries. Rather than just finding the most frequently used words in a document, the system finds the most important concepts associated with the document. The system also provides duality in that it may not only determine and provide the most important concepts associated with the document, but also may determine and provide other concepts that are closely related to the most important concepts.

For example, a user may begin by supplying a reference base of data in the same language as the data in question. Importantly, the disclosed system operates on more than just text, but it is described herein as textual use-cases for familiarity purposes. The user supplied reference base does not need any particular structure or annotation, and thus may exist as a folder of text files or a large, single text file.

The reference base is then read and parsed by the system, building an in-memory view which contains the necessary context for analysis to continue. In one embodiment, a delimiter is identified which allows the reference base to be parsed into individual units. For example, in text the individual unit may be words and for a genome the individual unit may be a particular genetic sequence that indicates the termination of a gene expression. Then, each delimited unit of data is parsed to build a full context across the reference base. This context includes the frequency of each occurrence of each unit of data, and the total number of occurrences of all units of data.

The reference base is then used to score each word, and the scores are scaled based on the size of the supplied data, ensuring that a representative sample is provided. After scoring completes, the user is presented with a prioritized list of concepts. For example, in a research paper on physics, sonic related concepts may be: “Einstein”—“relativity”; “Hawking”—“blackholes”; and “Maxwell”—“electromagnetism”.

Thus, a user can quickly see relationships between core concepts without needing to read the entire paper. The system provides a starting point for further research and can narrow down a significant expanse of papers and books into a manageable set of data to be read.

The output is generally textual, and may be invoked in a number of ways. For example, the output may be invoked via the user manually on-demand in a standalone application. The output may also be invoked via a web browser plugin that automatically runs whenever new content is displayed on-screen. The output may further be invoked via an application programming interface (API) made available from a cloud-based service to assess arbitrary data supplied by a caller.

Although certain examples provided herein may describe a user's information (e.g., a selection of content or data to be accessed) being stored in memory, each user may grant explicit permission for such user information to be stored. The explicit permission may be granted using privacy controls integrated into the disclosed system. If requested user information includes demographic information, the demographic information is aggregated on a group basis and not by an individual user. Each user may be provided notice that such user information will be stored with such explicit consent, and each user may at any time end having the user information stored, and may delete the stored user information. The stored user information may be encrypted to protect user security.

The user can delete the user information from memory. Additionally, the user can adjust appropriate privacy settings to selectively limit the types of user information stored in memory or select the memory in which the user information is stored (e.g., locally on the user's device as opposed to remotely a server). In many examples, the user information does not include and/or share the specific identification of the user (e.g., the user's name) unless otherwise specifically provided or directed by the user. Certain data may be treated in one or more ways before it is stored or used so that personally identifiable information is removed. For example, a user's identity may be treated so that no personal identifiable information can be determined for the user, or a user's geographic location may be generalized where location information is obtained (e.g., a city, ZIP code, or state level), so that a particular location of a user cannot be determined.

### EXAMPLE SYSTEM ARCHITECTURE

Architecturally, the representative technology can be deployed anywhere. For example, it may be preferable to operate on a server with a significant amount of computing power due to the computation that needs to occur to build and process the reference bases.

In one or more embodiments, the system will access a locally available database from the baseline that is built one-time in the language as the data in question. This database may be stored in a flat, binary structure, MySQL, NoSQL, or SQL, for example. A key requirement is memory residence, as the entire database needs to remain resident in memory while being processed. This is easily handled by standard technology since, for example, the database for English text is about 200 MB on-disk, which expands to approximately 1 GB in memory.

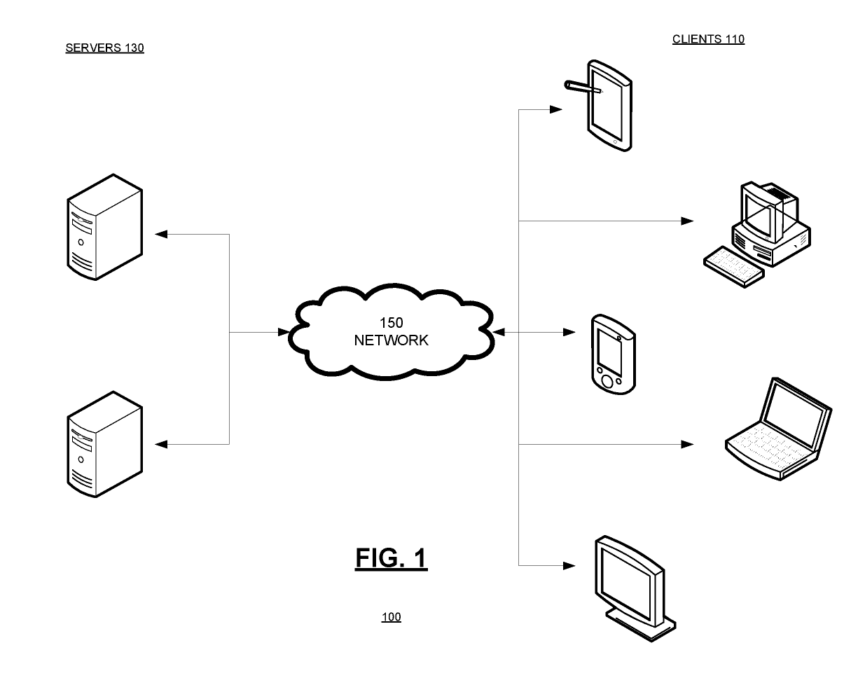

FIG. 1 illustrates an example architecture 100 for analyzing a body of data and providing the most relevant concepts related to the body of data. The architecture 100 includes servers 130 and clients 110 connected over a network 150.

The clients 110 can be, for example, desktop computers, mobile computers, tablet computers (e.g., including e-book readers), mobile devices (e.g., a smartphone or personal digital assistant), set top boxes (e.g., for a television), video game consoles, or any other devices having appropriate processor, memory, and communications capabilities for selection of a content item or a body of data. The system queries resources on the client 110 or over the network 150 from one of the servers 130 to obtain and display additional content and/or information related to the selected content.

One or more of the many servers 130 are configured to host various databases that include actions, documents, graphics, files and any other sources of content items or bodies of data. The databases may include, for each source in the database, information on the relevance or weight of the source with regards to the selected content item on the client 110. The application database on the servers 130 can be queried by clients 110 over the network 150. For purposes of load balancing, multiple servers 130 can host the application database either individually or in portions.

The servers 130 can be any device having an appropriate processor, memory, and communications capability for hosting content and information. The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

### EXAMPLE SYSTEM FOR NON-LINGUISTIC CONTENT ANALYSIS

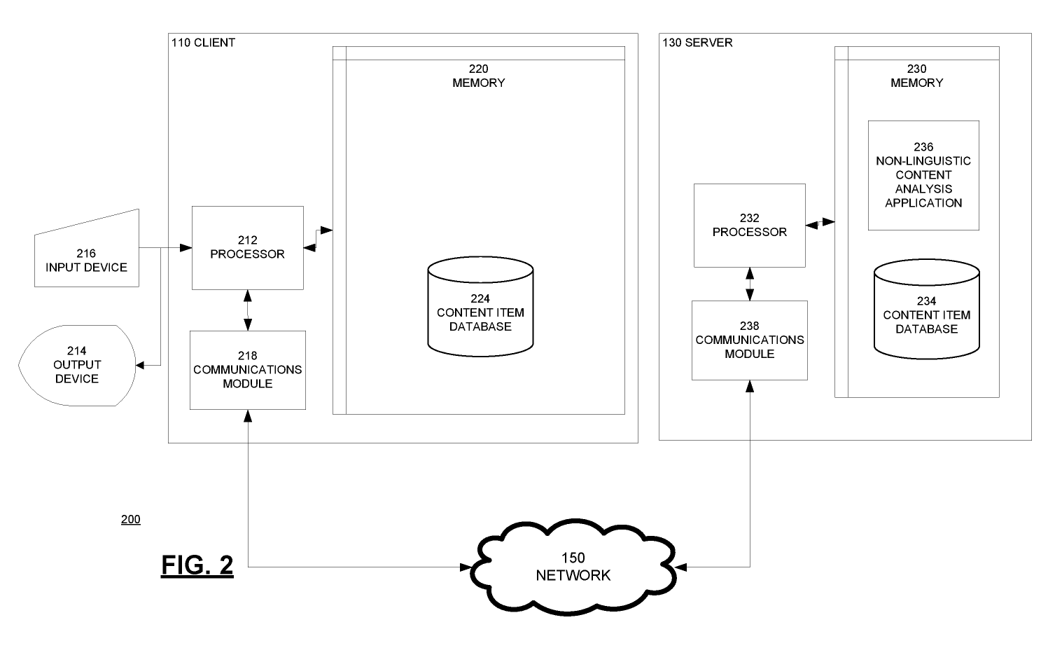

FIG. 2 is a block diagram 200 illustrating an example server 130 and client 110 in the architecture 100 of FIG. 1 according to certain aspects of the disclosure.

The client 110 and the server 130 are connected over the network 150 via respective communications modules 218 and 238. The communications modules 218 and 238 are configured to interface with the network 150 to send and receive information, such as data, requests, responses, and commands to other devices on the network. The communications modules 218 and 238 can be, for example, modems or Ethernet cards. The client 110 also includes an input device 216, such as a stylus, touchscreen, keyboard, or mouse, and an output device 214, such as a display. The server 130 includes a processor 232, the communications module 238, and a memory 230. The memory 230 includes a content item database 234 and a non-linguistic content analysis application 236.

The client 110 further includes a processor 212, the communications module 218, and a memory 220. The memory 220 includes a content item database 224. The content item database 224 may include, for example, a URL, a web page, a document such as a text document, a spreadsheet, a media file (e.g., audio, image, video, or any combination thereof), or any other data object/body of data configured to be interacted with by a user of the client 110. The content item database 224 may also include passive content items that are not inherently interactive, such as text, photographs, graphic images, emoji's, etc. The client 110 may be configured to provide interaction with a content item from the content item database 224, such as determining a selection of the content item, querying the content item database 234 on the server 130 for information relevant to the selected content item, and receiving the most suitable relevant information for display on the client 110.

The processors 212, 232 of the client 110, server 130 are configured to execute instructions, such as instructions physically coded into the processor 212, 232 instructions received from software in memory 220, 230 or a combination of both. For example, the processor 212 of the client 110 may execute instructions to select a content item from the content item database 224, to generate a query to the server 130 content item databases 234 for information relevant to the selected content item, and to provide the most relevant information for display on the client 110. The processor 232 of the server 130 may execute instructions to analyze a content selection or query from the client 110, to perform non-linguistic content analysis on the selected content, to search content item databases 234 for information most relevant to the selected content item, and to provide the most relevant information to the client 110. The client 110 is configured to access the application database 234 on the server 130 over the network 150 using the respective communications modules 218 and 238 of the client 110 and server 130.

Specifically, the processor 212 of the client 110 executes instructions causing the processor 212 to receive user input (e.g., using the input device 216) to determine selection of a content item/body of data within the content item database 224. For example, the user may open a social media post, open a text document, or engage in a verbal or written conversation.

The processor 212 of the client 110 may also execute instructions causing the processor 212 to generate a query for additional content and/or information related to the selected content and to display the relevant results of the search/query. For example, a user may download and open on the client 110 an academic research paper of interest. The processor 212 may then generate a query to the non-linguistic content analysis application 236 for the most important concepts associated with the academic research paper.

The processor 232 of the server 130 may automatically provide the most relevant results associated with the academic research paper where the results were previously determined by the non-linguistic content analysis application 236 and stored on the content item database 234 of the server 130. The processor 232 of the server 130 may conduct a current analysis of the academic research paper by the non-linguistic content analysis application 236 to provide an updated listing of the most relevant results associated with the academic research paper. Here, the non-linguistic content analysis application 236 may revise a previous determination of most relevant results based on information obtained since the previous determination. The most relevant concepts and/or content associated with the academic research paper as determined by the non-linguistic content analysis application 236 may be stored in the content item database 234 of the server 130 and provided to the client 110 for display on the output device 214.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

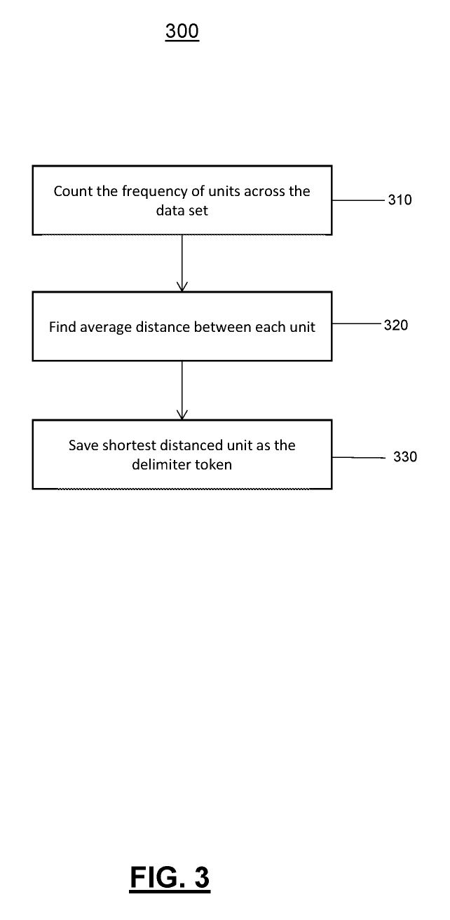

FIGS. 3-6 illustrates example processes 300, 400, 500, 600 for conducting non-linguistic content analysis for selected content using the example server 130 of FIG. 2. While FIGS. 3-6 are described with reference to FIG. 2, it should be noted that the process steps of FIGS. 3-6 may be performed by other systems.

As shown in FIG. 3, a process 300 identifies a token between components of a body of data if such a token exists. For example, for a body of data that consists of text words, a token may be a space in between words. Thus, a delimiter between text provides for not having to hardcode characters or symbols between words (e.g., a period, a space). The process 300 begins in step 310 by identifying a relative frequency of individual units of data in a selected content item/body of data (e.g., data set). For example, the relative frequency of a character or letter in a body of text may be determined. In step 320, the distance between each occurrence of the individual unit of data is measured. A determination of the unit with the least overall average distance is saved as a delimiter or delimiter token in step 330. The process 300 avoids the need to create assumptions about delimiters and allows coverage of types of data which are atypical in shape (e.g., full lines as a single concept, graphics separated by dots).

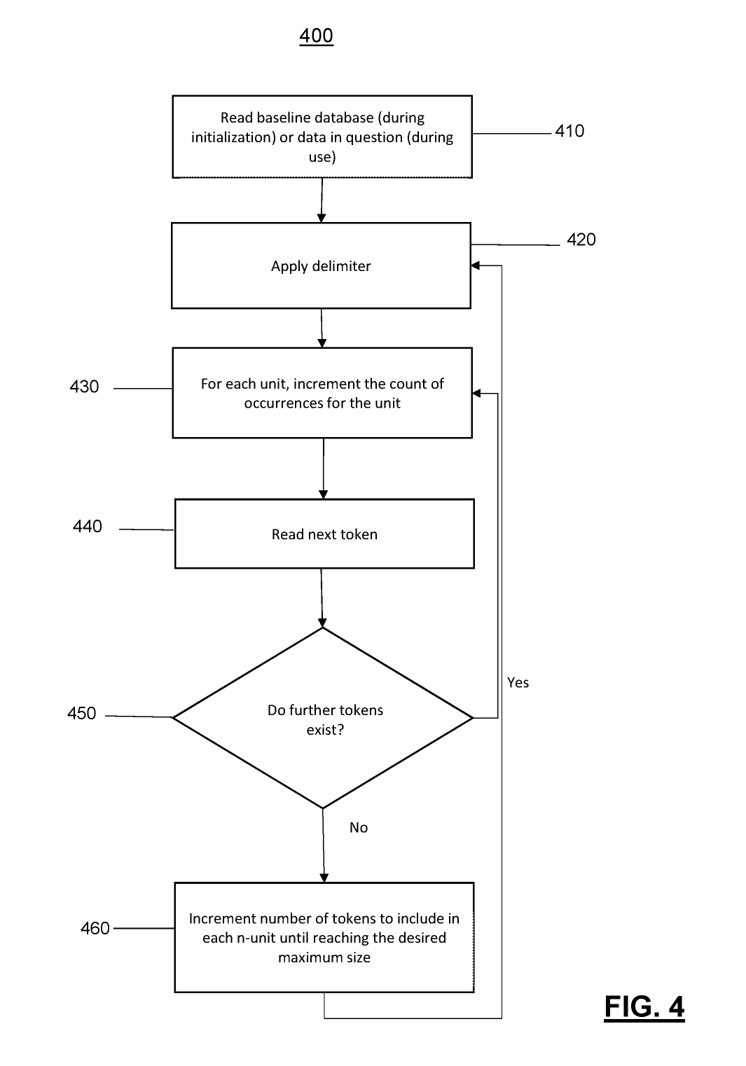

FIG. 4 illustrates a process 400 for initialization or building up of a non-linguistic content analysis database. In step 410, a baseline database is read during initialization or the selected body of data is read during use. In one aspect, a baseline may be determined from a body of data in the same language as the selected body of data. For example, for English text the Project Guttenberg resource may be used, or a downloaded archive of all Tweets or posts on forums in archive format. Such an archive may preferably be at least five times longer than the input text and include data from a variety of sources and authors. As another example, for non-English languages which can be analyzed textually, other datasets may exist or may be created by scanning books (e.g., optical character recognition (OCR)) or using public domain archives. If no other bodies of data are known in the same language as the selected body of data, the selected body of data itself may be used as the baseline. This allows rare texts in lost languages to be analyzed with a degree of accuracy that is correlated with the length of the text, if no reference database for that language exists. However, accuracy may be increased significantly when a reference baseline is available.

Once a baseline database has been read, a delimiter is applied in step 420. In step 430, for each unit the count of occurrences for that unit are incremented. The next token is read in step 440, and a determination whether further tokens exist is made in step 450. If a further token is determined to exist, the process repeats again from step 430. When a determination is made in step 450 that no further tokens exist, the number of tokens to include in each n-unit is incremented until reaching the desired maximum size in step 460. Thus, for example, process 400 may include reading a reference base, applying a delimiter to the reference base, calculating the total number of occurrences of each unit, and storing the total number of occurrences of all units to determine averages. In one or more aspects, units may also be grouped (e.g., searching for bi-units, tri-units, n-units across the reference database) to facilitate high level comparisons.

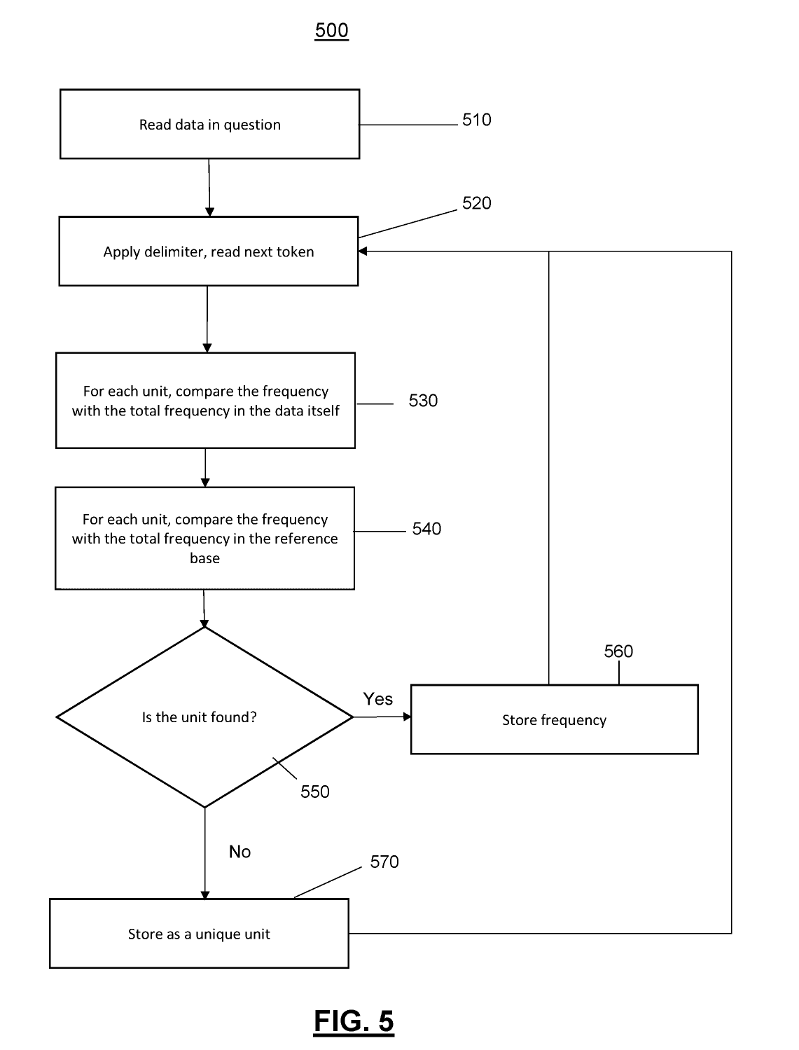

Process 500 shown in FIG. 5 begins in step 510 by reading the selected body of data (e.g., data in question). In step 520, the delimiter is applied and the next token is read. Here, the delimiter is applied to the selected body of data to break it into units. For each unit, the frequency of the unit is compared with the total frequency in the selected body of data itself in step 530. Thus, the popularity of a given unit within the selected body of data may be identified. Similarly, in step 540, for each unit the frequency of the unit is compared with the total frequency in the reference base. Thus, the popularity of a given unit may be correlated with the reference base by looking up the associated popularity derived from parsing the reference base. This identifies units or groups of units that are used relatively frequently in the selected body of data compared to how often they are used in the reference base. For example, a unit being used significantly more frequently in a particular body of data is indicative of the importance of that unit as a representative concept for the body of data.

In step 550, a determination is made whether a unit is found in the reference base. If the unit is found, a scored entry is stored which rates the number of occurrences in the selected body of data to the number of occurrences in the reference base in step 560, after which the process 500 may be repeated starting at step 520. If the unit is not found in the reference base, in step 570 the unit is stored as a unique unit. A unique unit is of particular importance as it indicates a newly introduced concept within the selected body of data.

After all units are scored, the average per-unit score is determined and adjusted based on the size of the data. The factor by which the result is adjusted is calibrated based on a knowledge of the types of data either manually or automatically (e.g., applying a factor of “100” to novels versus a factor of “1” to a Tweet to reflect their relative length). For example, the automatic scaling effect applied here may be derived by looking at each of the inputs in the reference base and calculating its average size, then comparing it to the input data in question (e.g., selected body of data). The scaling effect is equal to the ratio of the input data to the average reference size.

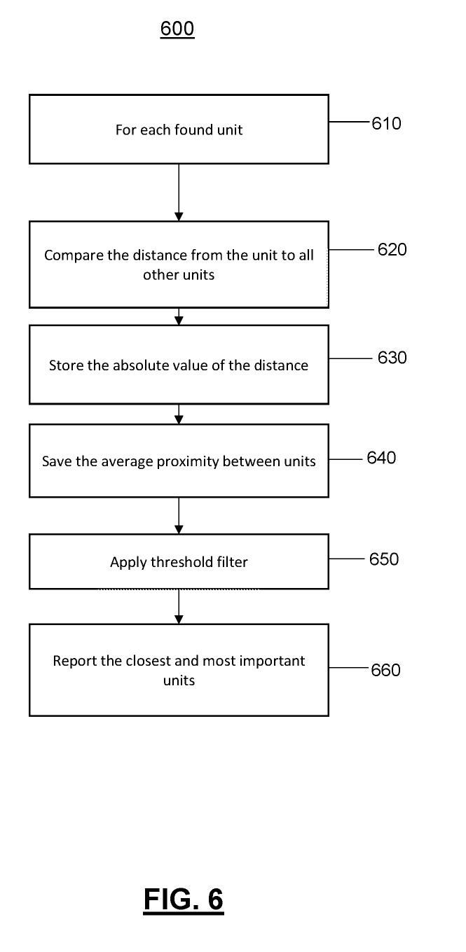

In FIG. 6, process 600 provides a comparison process for each found unit that begins in step 610. In step 620, the distance of the found unit to all other units is compared, for example, by comparing the offset of each instance of the context to the offset of each instance of another concept. The absolute value of the distance between units is saved in step 630, and in step 640 the average proximity between units is saved. For example, the proximity of a pair of units may be scaled based on the average distance within the data to prevent individually rare units from appearing closer just because there are very few data points. In step 650, a threshold filter is applied. For example, important concepts may be ones that exist greater than this threshold relative to the reference base, or that are unique. Also, each concept may be reported individually. After all units are related to all other units and the proximity between units is sorted, the topmost related units are reported in step 660, the topmost units representing the closest related and most important keywords/concepts in the selected body of data. Accordingly, unlike latent semantic analysis, these relationships may take place across paragraph or sentence boundaries, providing for more absolute correlation of concepts regardless of higher level delimiters like new lines, for example.

An example will now be described using the example processes 300-600 of FIGS. 3-6, a client 110 that is a smartphone and having an output device 214 that is a flat panel display, an input device 216 that is a touch screen interface, a content item database 224 that stores content that can be displayed on the smartphone, and a communications module 218 that provides for communication between the smartphone client 110 and a network 150 of servers 130, with at least one server 130 having a content item database 234 and a non-linguistic content analysis application 236.

The process begins the when non-linguistic content analysis application 236 on a server 130 is initialized and searches all corporate resources (e.g., corporate archive). Here, the non-linguistic content analysis application 236 may search all corporate databases, code, libraries, image storage and any other corporate data sources. The non-linguistic content analysis application 236 then performs processes 300-600 on server 130 to attribute keywords to each concept and to score/rank each keyword. The non-linguistic content analysis application 236 may run continuously to analyze any new content or data that is added to the corporate archive and rescore/rerank the keywords. Thus, at any given point in time, the non-linguistic content analysis application 236 will provide the same highest ranked keywords for any corporate queries having the same text term, picture, emoji and the like.

For example, if a research paper is stored on a corporate resource, the non-linguistic content analysis application 236 pulls apart the content and assigns the most relevant keywords to concepts in the paper. As another example, a researcher may be looking for research papers on “relativity,” wherein the non-linguistic content analysis application 236 may assign higher scores/ranks to specific research papers on Einstein's theory of relativity than for a paper that obliquely mentions the word relativity. Thus, when a corporate query is received regarding a research paper, the system does not need to look through every word of the research paper in response to the query, but instead only searches the already assigned/known keywords for the research paper. This provides a tremendously lower search footprint and provides a much more efficient use of the server processor and memory, as well as significantly reducing the response time for providing the most relevant concepts or content. In other words, the subject technology requires less processing to execute the search, requires less memory for storage/buffering during the search, and provides a much faster search and/or return of the most relevant results.

As another example, for a typical search query a user may enter the term “Einstein” into a search engine, which may respond with a link to an online encyclopedia on another server, which may provide a link to information about an astrophysics symposium on yet another server. By contrast, the non-linguistic content analysis application 236 may provide a list of search engine results, the online encyclopedia page for Einstein, and information about the astrophysics symposium all from one server 130 in response to an automatically generated query of the term “Einstein.” Thus, the subject technology may provide increased efficiency of network bandwidth as the client 110 sends a query to a server 130 and that server 130 replies with the most relevant concepts or data associated with the queried body of data, all without requiring multiple queries to multiple servers. Further, less overall server memory is required over the corporate network as all search/comparison processes may be provided by a single server 130 and thus only affecting the memory of that server 130.

The subject technology provides for search and comparison of non-text bodies of data, such as pictures, snaps, emojis, and the like. Here, the non-linguistic content analysis application 236 may provide a look up table that takes in Unicode related to the visual data and assigns a text label to that visual data. Thus, the assigned text label may then be used as a searchable term for comparison purposes. For example, an emoji may look like a baseball, which is then assigned the text label “baseball” to be used for future comparison processes. Thus, all query items may be reduced to generic text attributes for providing more efficient and speedy results having the most relevance to the selected body of data.

The subject technology is also language agnostic. For example, if a query is generated for the Russian term for “baseball,” then the search and comparison processes may be conducted using the Russian term, and the most relevant results returned to the query may be in Russian as well. However, a translation layer may be provided at the client side. Continuing with the above example, the translation layer on the client 110 may receive the top ranked most relevant results in Russian for a query of the Russian term for “baseball,” wherein the translation layer may translate the top ranked Russian results into English.

### Hardware Overview

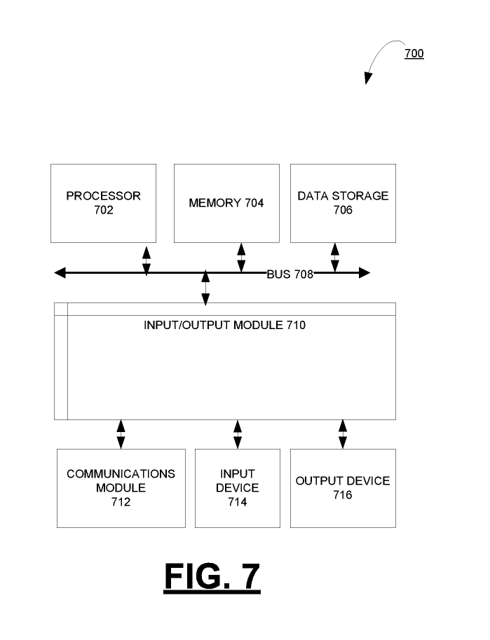

FIG. 7 is a block diagram illustrating an example computer system 700 with which the client 110 and server 130 of FIG. 2 can be implemented. In certain aspects, the computer system 700 may be implemented using hardware or a combination of software and hardware, either in a dedicated server or integrated into another entity or distributed across multiple entities.

Computer system 700 (e.g., client 110 and server 130) includes a bus 708 or other communication mechanism for communicating information, and a processor 702 (e.g., processor 212 and 236) coupled with bus 708 for processing information. According to one aspect, the computer system 700 is implemented as one or more special-purpose computing devices. The special-purpose computing device may be hard-wired to perform the disclosed techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques. By way of example, the computer system 700 may be implemented with one or more processors 702. Processor 702 may be a general-purpose microprocessor, a microcontroller, a Digital Signal Processor (DSP), an ASIC, a FPGA, a Programmable Logic Device (PLD), a controller, a state machine, gated logic, discrete hardware components, or any other suitable entity that can perform calculations or other manipulations of information.

Computer system 700 can include, in addition to hardware, code that creates an execution environment for the computer program in question, e.g., code that constitutes processor firmware, a protocol stack, a database management system, an operating system, or a combination of one or more of them stored in an included memory 704 (e.g., memory 220 and 230), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 708 for storing information and instructions to be executed by processor 702. The processor 702 and the memory 704 can be supplemented by, or incorporated in, special purpose logic circuitry. Expansion memory may also be provided and connected to computer system 700 through input/output module 710, which may include, for example, a SIMM (Single In Line Memory Module) card interface. Such expansion memory may provide extra storage space for computer system 700 or may also store applications or other information for computer system 700. Specifically, expansion memory may include instructions to carry out or supplement the processes described above and may include secure information also. Thus, for example, expansion memory may be provided as a security module for computer system 700 and may be programmed with instructions that permit secure use of computer system 700. In addition, secure applications may be provided via the SIMM cards, along with additional information, such as placing identifying information on the SIMM card in a non-hackable manner.

The instructions may be stored in the memory 704 and implemented in one or more computer program products, i.e., one or more modules of computer program instructions encoded on a computer readable medium for execution by, or to control the operation of, the computer system 700, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 704 may also be used for storing temporary variable or other intermediate information during execution of instructions to be executed by processor 702.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 700 further includes a data storage device 706 such as a magnetic disk or optical disk, coupled to bus 708 for storing information and instructions. Computer system 700 may be coupled via input/output module 710 to various devices. The input/output module 710 can be any input/output module. Example input/output modules 710 include data ports such as USB ports. In addition, input/output module 510 may be provided in communication with processor 702, so as to enable near area communication of computer system 700 with other devices. The input/output module 710 may provide, for example, for wired communication in some implementations, or for wireless communication in other implementations, and multiple interfaces may also be used. The input/output module 710 is configured to connect to a communications module 712. Example communications modules 712 (e.g., communications modules 218 and 238) include networking interface cards, such as Ethernet cards and modems.

The components of the system can be interconnected by any form or medium of digital data communication, e.g., a communication network. The communication network (e.g., network 150) can include, for example, any one or more of a PAN, a LAN, a CAN, a MAN, a WAN, a BBN, the Internet, and the like. Further, the communication network can include, but is not limited to, for example, any one or more of the following network topologies, including a bus network, a star network, a ring network, a mesh network, a star-bus network, tree or hierarchical network, or the like.

For example, in certain aspects, communications module 712 can provide a two-way data communication coupling to a network link that is connected to a local network. Wireless links and wireless communication may also be implemented. Wireless communication may be provided under various modes or protocols, such as GSM (Global System for Mobile Communications), Short Message Service (SMS), Enhanced Messaging Service (EMS), or Multimedia Messaging Service (MIMS) messaging, CDMA (Code Division Multiple Access), Time division multiple access (TDMA), Personal Digital Cellular (PDC), Wideband CDMA, General Packet Radio Service (GPRS), or LTE (Long-Term Evolution), among others. Such communication may occur, for example, through a radio-frequency transceiver. In addition, short-range communication may occur, such as using a BLUETOOTH, WI-FI, or other such transceiver.

In any such implementation, communications module 712 sends and receives electrical, electromagnetic or optical signals that carry digital data streams representing various types of information. The network link typically provides data communication through one or more networks to other data devices. For example, the network link of the communications module 712 may provide a connection through local network to a host computer or to data equipment operated by an Internet Service Provider (ISP). The ISP in turn provides data communication services through the world wide packet data communication network now commonly referred to as the Internet. The local network and Internet both use electrical, electromagnetic or optical signals that carry digital data streams. The signals through the various networks and the signals on the network link and through communications module 712, which carry the digital data to and from computer system 700, are example forms of transmission media.

Computer system 700 can send messages and receive data, including program code, through the network(s), the network link and communications module 712. In the Internet example, a server might transmit a requested code for an application program through Internet, the ISP, the local network and communications module 712. The received code may be executed by processor 702 as it is received, and/or stored in data storage 706 for later execution.

In certain aspects, the input/output module 710 is configured to connect to a plurality of devices, such as an input device 714 (e.g., input device 216) and/or an output device 716 (e.g., output device 214). Example input devices 714 include a stylus, a finger, a keyboard and a pointing device, e.g., a mouse or a trackball, by which a user can provide input to the computer system 700. Other kinds of input devices 714 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 716 include display devices, such as a LED (light emitting diode), CRT (cathode ray tube), LCD (liquid crystal display) screen, a TFT LCD (Thin-Film-Transistor Liquid Crystal Display) or an OLED (Organic Light Emitting Diode) display, for displaying information to the user. The output device 716 may comprise appropriate circuitry for driving the output device 716 to present graphical and other information to a user.

According to one aspect of the present disclosure, the client 110 and server 130 can be implemented using a computer system 700 in response to processor 702 executing one or more sequences of one or more instructions contained in memory 704. Such instructions may be read into memory 704 from another machine-readable medium, such as data storage device 706. Execution of the sequences of instructions contained in main memory 704 causes processor 702 to perform the process steps described herein. One or more processors in a multi-processing arrangement may also be employed to execute the sequences of instructions contained in memory 704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components.

Computing system 700 can include clients and servers. A client and server are generally remote from each other and typically interact through a communication network. The relationship of client and server arises by virtue of computer programs running on the respective computers and having a client-server relationship to each other. Computer system 700 can be, for example, and without limitation, a desktop computer, laptop computer, or tablet computer. Computer system 700 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer-readable medium” as used herein refers to any medium or media that participates in providing instructions or data to processor 702 for execution. The term “storage medium” as used herein refers to any non-transitory media that store data and/or instructions that cause a machine to operate in a specific fashion. Such a medium may take many forms, including, but not limited to, non-volatile media, volatile media, and transmission media. Non-volatile media include, for example, optical disks, magnetic disks, or flash memory, such as data storage device 706. Volatile media include dynamic memory, such as memory 704. Transmission media include coaxial cables, copper wire, and fiber optics, including the wires that comprise bus 708. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

As used in this specification of this application, the terms “computer-readable storage medium” and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire and fiber optics, including the wires that comprise bus 708. Transmission media can also take the form of acoustic or light waves, such as those generated during radio-wave and infra-red data communications. Furthermore, as used in this specification of this application, the terms “computer”, “server”, “processor”, and “memory” all refer to electronic or other technological devices. These terms exclude people or groups of people. For the purposes of the specification, the terms display or displaying means displaying on an electronic device.

In one aspect, a method may be an operation, an instruction, or a function and vice versa. In one aspect, a clause or a claim may be amended to include some or all of the words (e.g., instructions, operations, functions, or components) recited in either one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A computer-implemented method for non-linguistic content analysis of a selected body of data, the method comprising:
identifying a delimiter token;
parsing a reference base into reference units based on the delimiter token;
calculating and storing a frequency of each occurrence of each reference unit of the reference base and a total number of occurrences of all reference units of the reference base;
parsing the selected body of data into data units;
calculating and storing a score for each data unit of the selected body of data; and
providing a ranked list of concepts associate with the selected body of data.

2. The method of claim 1, wherein the identifying a delimiter token comprises:
counting a frequency of units across a data set;
determining an average distance between each unit of the data set; and
identifying a shortest distanced unit as the delimiter token.

3. The method of claim 1, wherein the reference base comprises a reference body of data in a same language as the selected body of data.

4. The method of claim 1, wherein the reference base comprises the selected body of data.

5. The method of claim 1, further comprising:
grouping reference units of the reference base; and
searching for the grouped reference units across the reference base.

6. The method of claim 5, wherein the grouping comprises one of bi-units, tri-units, n-units.

7. The method of claim 1, further comprising:
identifying a popularity of a given data unit of the selected body of data by comparing a frequency of the given data unit of the selected body of data with a total frequency of all data units in the selected body of data.

8. The method of claim 7, further comprising:
identifying a popularity of an associated reference unit of the reference base by comparing the stored frequency of the associated reference unit and the stored total number of occurrences of all reference units; and
correlating the identified popularities of the given data unit and the associated reference unit.

9. The method of claim 1, further comprising:
searching the reference base for occurrences of a given data unit of the selected body of data; and
storing the given data unit as a unique unit if there are no occurrences of the given data unit in the reference base.

10. The method of claim 1, further comprising:
calculating an average per-unit score for the selected body of data based on the stored scores of each data unit of the selected body of data; and
adjusting the average per-unit score based on a size of the selected body of data.

11. The method of claim 10, wherein the adjusting the average per-unit score comprises an automatic scaling effect based on a ratio of a given data unit size to an average reference unit size.

12. The method of claim 11, further comprising:
applying a threshold filter to identify data units greater than the adjusted average per-unit score.

13. The method of claim 1, further comprising:
relating each data unit to every other data unit; and
storing a proximity score for each pair of related data units.

14. The method of claim 13, further comprising:
sorting the proximity scores; and
reporting a number of pairs of related data units with the highest proximity scores.

15. A system for providing non-linguistic content analysis of a selected body of data, the system comprising:
a memory; and
a processor configured to execute instructions which, when executed, cause the processor to:
identify a delimiter token;
parse a reference base into reference units based on the delimiter token;
calculate and store a frequency of each occurrence of each reference unit of the reference base and a total number of occurrences of all reference units of the reference base;
parse the selected body of data into data units;
calculate and store a score for each data unit of the selected body of data; and
provide a ranked list of concepts associate with the selected body of data.

16. The system of claim 15, further comprising instructions that cause the processor to:
identify a popularity of a given data unit of the selected body of data by comparing a frequency of the given data unit of the selected body of data with a total frequency of all data units in the selected body of data;
identify a popularity of an associated reference unit of the reference base by comparing the stored frequency of the associated reference unit and the stored total number of occurrences of all reference units; and
correlate the identified popularities of the given data unit and the associated reference unit.

17. The system of claim 15, further comprising instructions that cause the processor to:
search the reference base for occurrences of a given data unit of the selected body of data;
store the given data unit as a unique unit if there are no occurrences of the given data unit in the reference base; and
apply a threshold filter to obtain a filtered list of top scored data units and unique units.

18. A non-transitory machine-readable storage medium comprising machine-readable instructions for causing a processor to execute a method for providing non-linguistic content analysis of a selected body of data, the method comprising:
parsing a reference base into reference units based on a delimiter token;
calculating and storing a frequency of each occurrence of each reference unit of the reference base and a total number of occurrences of all reference units of the reference base;
parsing the selected body of data into data units based on the delimiter token;
calculating and storing a score for each data unit of the selected body of data; and
providing a ranked list of concepts associated with the selected body of data.

19. The non-transitory machine-readable storage medium of claim 18, further comprising:
counting the frequency of units across a data set;
determining an average distance between each unit of the data set; and
identifying a shortest distanced unit as the delimiter token.

20. The non-transitory machine-readable storage medium of claim 18, further comprising:
identifying a popularity of a given data unit of the selected body of data by comparing a frequency of the given data unit of the selected body of data with a total frequency of all data units in the selected body of data;
identifying a popularity of an associated reference unit of the reference base by comparing the stored frequency of the associated reference unit and the stored total number of occurrences of all reference units; and
correlating the identified popularities of the given data unit and the associated reference unit.
